(19) United States
(12) Patent Application Publication
(10) Pub. No.: US 2008/0027196 A1
(43) Pub. Date: Jan. 31, 2008

(54) Organic Material For Ferroelectric Semiconductor Device

(75) Inventor: Byung-Eun Park, Seoul (KR)

Correspondence Address: BRUCE E. LILLING;LILLING & LILLING PLLC, P.O. BOX 560, GOLDEN BRIDGE, NY, 10526, US

(73) Assignee: University of Seoul Foundation of Academic Corporation, Seoul (KR)

(21) Appl. No.: 11/721,579

(22) PCT Filed: Sep. 7, 2006
(86) PCT No.: PCT/KR06/03550

§ 371 Date: Jun. 13, 2007

(30) Foreign Application Priority Data
Sep. 29, 2005 (KR) 10-2005-0091016

(51) Int. Cl. C08F 14/22

(52) U.S. Cl. 526/242

(57) ABSTRACT

Disclosed relates to an organic material for a ferroelectric semiconductor device, which can be effectively used as a dielectric material of the ferroelectric semiconductor device, such as PVDF, etc. The PVDF having four crystal structures of α, β, γ, and δ shows a good hysteresis characteristic in the crystal structure of β-phase. A PVDF thin film having a crystal structure of β-phase has excellent hysteresis characteristics that show a capacitance value is decreased with the increase of an applied voltage in about 0 to 1V and increased with the decrease of an applied voltage in about 0 to −1V. A ferroelectric organic material having a crystal structure of β-phase is used on a channel region (54) between source and drain regions (52 and 53) of a silicon substrate (51). As ferroelectric organic materials, polyvinylidene fluoride (PVDF), PVDF polymer, PVDF copolymer or PVDF terpolymer and, further, odd-numbered nylon, cyano-polymer and their polymer or copolymer, etc. may be used.

### TECHNICAL FIELD

The present invention relates to a ferroelectric semiconductor device and, more particularly, to an organic material for a ferroelectric semiconductor device that can be effectively used as a dielectric material for the ferroelectric semiconductor device.

### BACKGROUND ART

At present, memory devices have been necessarily applied to most electronic apparatus including personal computers. Such memory devices may be classified roughly into ROMs, such as electrically programmable read only memory (EPROM), electrically erasable PROM (EEPROM), flash ROM, etc., and RAMs, such as static random access memory (SRAM), dynamic RAM (DRAM), ferroelectric RAM (FRAM), etc. The memory device is fabricated generally by arranging capacitors and transistors on a semiconductor wafer.

In the conventional memory devices, various researches aimed mainly at increasing the density of memory cells have been made. However, non-volatile memory devices that can maintain data stored therein without a separate power supply have attracted attention recently. Accordingly, numerous researches aimed at using ferroelectric materials for such memory devices have continued to progress.

At present, as ferroelectric materials applied to the memory devices, inorganic compounds such as lead zirconate titanate (PZT), strontium bismuth tantalite (SBT), lanthanum-substituted bismuth titanate (BLT), etc. have been mainly used. However, such inorganic ferroelectrics have some drawbacks in that they are very expensive; the polarization characteristics may be deteriorated according to the lapse of time; the formation of thin films requires a high temperature treatment; and various expensive equipments are needed in using the inorganic ferroelectrics.

### DISCLOSURE

Technical Problem

The present invention has been contrived taking the above-described circumstances into consideration and, an object of the present invention is to provide an environment-friendly and low cost organic material having excellent ferroelectric characteristics for semiconductor device.

Technical Solution

To accomplish an object in accordance with the present invention, there is provided, in ferroelectric materials used in manufacturing semiconductor devices, a ferroelectric organic material having a crystal structure of β-phase.

Moreover, the ferroelectric organic material is a polyvinylidene fluoride (PVDF).

Furthermore, the ferroelectric organic material is one selected from the group consisting of PVDF polymer, PVDF copolymer PVDF terpolymer, odd-numbered nylon, cyano-polymer, their polymer and copolymer.

### DESCRIPTION OF DRAWINGS

The above and other features of the present invention will be described with reference to certain exemplary embodiments thereof illustrated the attached drawings in which:

FIG. 1 is a graph illustrating voltage-capacitance characteristics of a general organic material;

FIGS. 2 and 3 are graphs illustrating voltage-capacitance characteristics of a ferroelectric organic material applied to the present invention;

FIG. 4 is a sectional view depicting a structure of a memory device using a ferroelectric organic material in accordance with a preferred embodiment of the present invention; and

FIG. 5 is a sectional view depicting another structure of a memory device using a ferroelectric organic material in accordance with another embodiment of the present invention.

### MODE FOR THE INVENTION

Hereinafter, the present invention will now be described more fully with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art.

First, the basic concept of the present invention will now be described.

At present, various kinds of organic materials having ferroelectric characteristics have been known. The typical organic materials may be exemplified by polyvinylidene fluoride (PVDF), PVDF polymer, PVDF copolymer or PVDF terpolymer and, further, odd-numbered nylon, cyano-polymer and their polymer or copolymer. Among such ferroelectric organic materials described above, PVDF, its polymer, copolymer and terpolymer have been mainly studied as organic semiconductor materials.

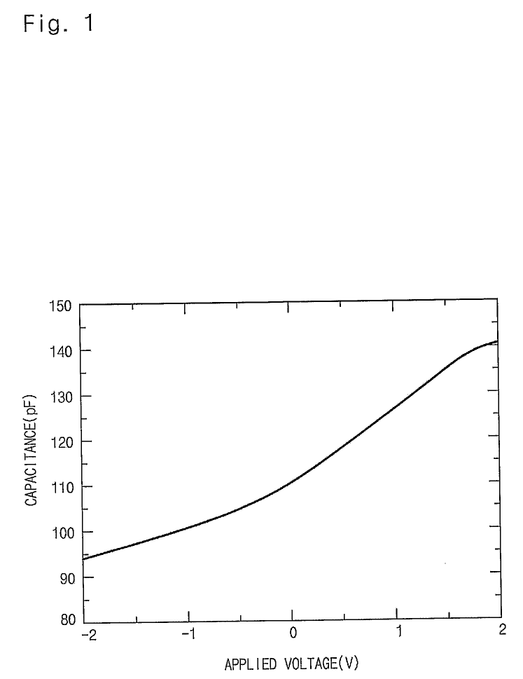

In general, to utilize such ferroelectric organic materials in manufacturing memory devices, corresponding organic materials should have hysteresis polarization characteristics against the applied voltages. However, the PVDF described above shows the capacitances increased according to the applied voltages, and does not have the hysteresis characteristics suitably applied to the memory devices, as illustrated in FIG. 1.

According to the study results of the inventor of the present invention, it has been confirmed that the PVDF having four crystal structures of α, β, γ and δ shows a good hysteresis polarization characteristic in the crystal structure of β-phase. Here, to crystallize the PVDF with β-phase, the PVDF is deposited on a semiconductor substrate and then cooled rapidly at a temperature, where phase transitions occur, e.g., 60 to 70° C., and preferably, about 65° C., or at a temperature, where the PVDF shows β-phases.

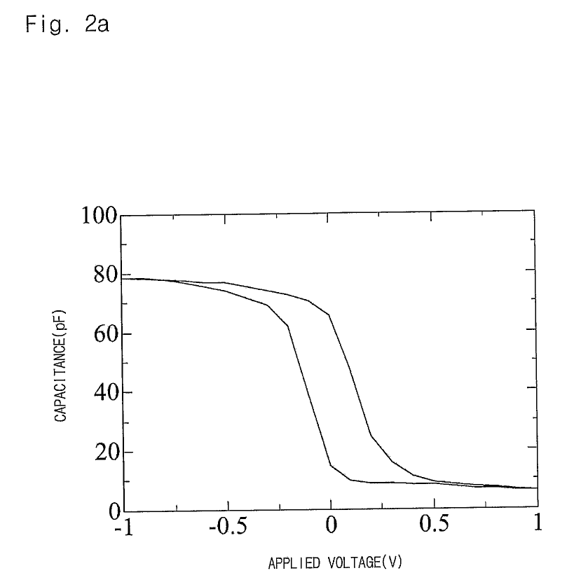

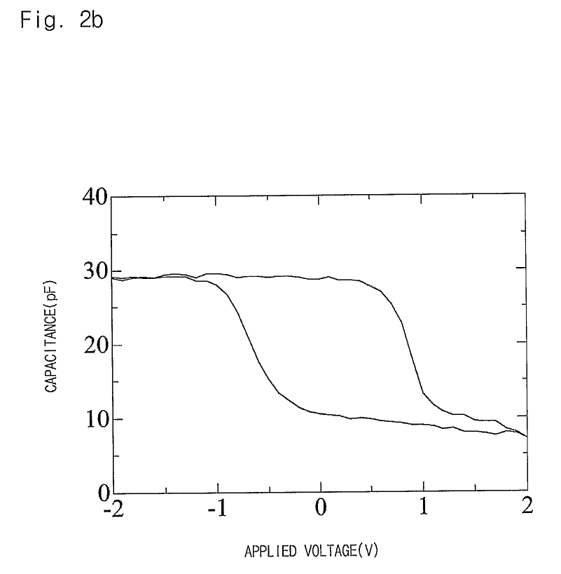

FIGS. 2a and 2b are graphs illustrating polarization characteristics of the PVDF thin film, manufactured in accordance with the present invention, against the voltages applied thereto, in which the measurement was made by forming a PVDF thin film of β-phase on the silicon substrate, forming upper electrodes on the PVDF thin film and then applying specific voltages between the silicon substrate and the upper electrode. Particularly, FIG. 2a illustrates a PVDF thin film formed in a thickness of 10 nm, approximately, and FIG. 2b depicts a PVDF thin film formed in a thickness of 60 nm, approximately. Such thin films were formed in such a manner that after forming a PVDF having a specific thickness via a spin-coating process below 3,000 rpm and an annealing process above 120° C. for example, the temperature of the PVDF thin film was monotonously lowered on a hot plate, and finally the PVDF thin film was cooled rapidly at 65° C., for example.

As can be seen in FIGS. 2a and 2b, the PVDF thin film manufactured in accordance with the present invention has excellent hysteresis characteristics in that the capacitance value is decreased with the increase of the applied voltage in about 0 to 1V, and the capacitance value is increased with the decrease of the applied voltage in about 0 to −1V.

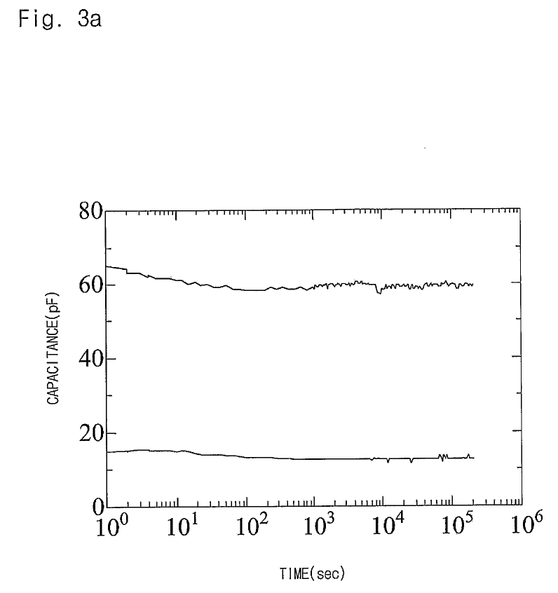

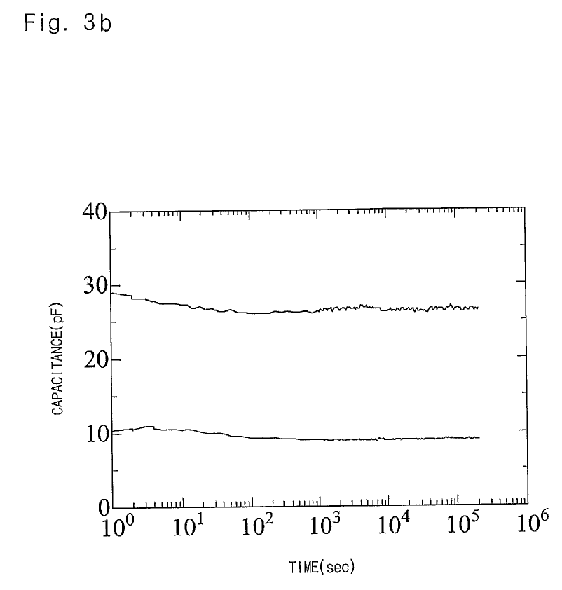

Moreover, FIGS. 3a and 3b are graphs measuring the changes of the capacitance values of the PVDF thin film formed as described above according to the lapse of time, in which FIGS. 3a and 3b correspond to FIGS. 2a and 2b, respectively.

As can be learned from FIGS. 3a and 3b, it has been confirmed that the capacitance value of the PVDF thin film formed in accordance with the present invention is not changed according to the lapse of time but maintained over a specific time period.

Accordingly, the PVDF thin film of the present invention has the following characteristics as confirmed from FIGS. 2 and 3.

First, the PVDF thin film of the present invention shows a capacitance value over a specific value at 0V. This means that the polarization value of the PVDF thin film is not changed but maintained at 0V, where no voltages are applied from the outside. That is, the PVDF thin film in accordance with the present invention can be effectively used as a material for manufacturing a non-volatile memory device.

Second, the PVDF thin film in accordance with the present invention shows a memory characteristic even in a range below 1V. That is, it is possible to record and delete data at a very low voltage. Accordingly, the PVDF in accordance with the present invention can be effectively used in materializing the memory devices that operate at low voltages.

Last, the PVDF thin film in accordance with the present invention has a property that the capacitance value is not changed but maintained uniformly. That is, the PVDF thin film in accordance with the present invention has an excellent data preservation property that preserves data value recorded once over a specific time period.

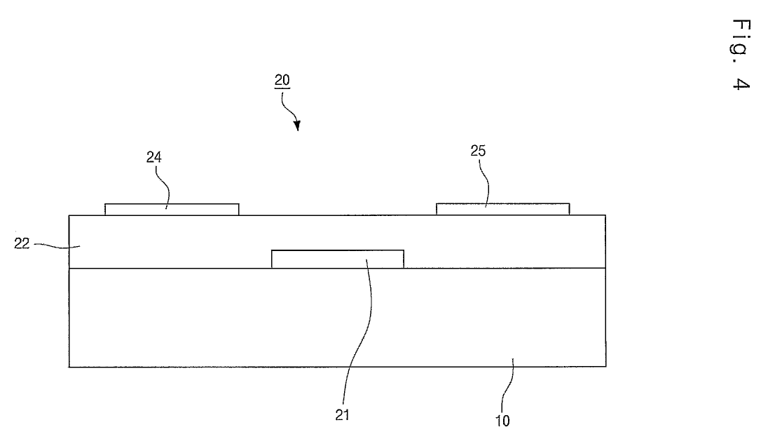

FIG. 4 is a sectional view depicting a structure of a memory device using a ferroelectric organic material in accordance with a preferred embodiment of the present invention.

In the figure, a memory cell 20 is formed on a substrate 10. The substrate 10 is made of conductive materials such as general silicon, metal and the like. Moreover, the substrate 10 may be formed with organic materials such as paper, coated with parylene, or flexible plastic, etc. Here, available organic materials may include polyimide (PI), polycarbonate (PC), polyethersulfone (PES), polyetheretherketone (PEEK), polybutyleneterephthalate (PBT), polyethyleneterephthalate (PET), polyvinylchloride (PVC), polyethylene (PE), ethylene copolymer, polypropylene (PP), propylene copolymer, poly(4-methyl-1-pentene)(TPX), polyarylate (PAR), polyacetal (POM), polyphenyleneoxide (PPO), polysulfone (PSF), polyphenylenesulfide (PPS), polyvinylidenechloride (PVDC), polyvinylacetate (PVAC), polyvinylalcohol (PVA), polyvinylacetal (PVAL), polystyrene (PS), AS resin, ABS resin, polymethylmethacrylate (PMMA), fluorocarbon resin, phenol-formaldehyde (PF) resin, melamine-formaldehyde (MF) resin, urea-formaldehyde (UF) resin, unsaturated polyester (UP) resin, epoxy (EP) resin, diallylphthalate (DAP) resin, polyurethane (PUR), polyamide (PA), silicon (SI) resin or their mixtures and compounds.

A gate electrode 21 as a lower electrode is formed on the substrate 10 via a well-known method. Such gate electrode 21 is made of aurum, argentum, aluminum, platinum, indium-tin oxide (ITO), strontium titanate (SrTiO₃); or other conductive metal oxides, and their alloys and compounds; or mixtures, compounds or multilayer compounds, of which base are conductive polymers, such as polyaniline, poly(3,4-ethylenedioxythiophene)/polystyrenesulfonate (PEDOT:PSS), etc.

Subsequently, a ferroelectric layer 22 including a PVDF, for example, is formed over the gate electrode 21. Here, the ferroelectric layer 22 may be formed via spin coating, vacuum deposition, screen printing, jet printing or Langmuir-Blodgett (LB) technique, etc.

Particularly, after forming the ferroelectric layer 22, the substrate 10 is put on a hot plate and heat is applied to the substrate 10 so that the temperature of the substrate 10 is raised over a specific temperature. Here, the temperature of the hot plate is set over a temperature, where the crystal structure of the ferroelectric layer 22 shows β-phases.

Subsequently, the temperature of the substrate 10 is lowered monotonously by controlling the hot plate and, if the temperature of the substrate 10, more accurately, the temperature of the ferroelectric layer 22 is lowered at 60 to 70° C., preferably, at 65° C., where the ferroelectric shows β-phases, the temperature of the substrate 10 is cooled rapidly so that the crystal structure of the ferroelectric layer 22 is fixed to be β-phase.

Next, a drain electrode 24 and a source electrode 25 are arranged as upper electrodes on the ferroelectric layer 22.

Here, the drain electrode 24 and the source electrode 25 may be formed with aurum, argentum, aluminum, platinum, indium-tin oxide (ITO), strontium titanate (SrTiO₃); or conductive metal oxides, and their alloys and compounds; or mixtures, compounds or multilayer compounds, of which bases are conductive polymers, such as polyaniline, poly(3,4-ethylenedioxythiophene)/polystyrenesulfonate (PEDOT:PSS), etc.

In the above embodiment, after forming the ferroelectric layer 22, i.e., a PVDF layer on the gate electrode 21 of the substrate 10, the crystal structure of the PVDF layer is determined to be of β-phase in such a manner that the substrate 10 is cooled rapidly at a temperature, where the PVDF layer shows β-phases.

However, the above-described method of manufacturing the memory device may cause a problem in that the crystal structure of the ferroelectric layer 22 is changed by the heat applied to the substrate 10 when fabricating the drain electrode 24 and the source electrode 25 after forming the ferroelectric layer 22.

Accordingly, it is desirable that the crystal structure of the ferroelectric layer 22 be established after completing the process of manufacturing a memory device by forming the drain electrode 24 and the source electrode 25, not establishing the crystal structure of the ferroelectric layer 22 directly after forming the ferroelectric layer 22. That is, it is desirable that the crystal structure of the ferroelectric layer 22 be established in such a manner that the structure, after forming the drain electrode 24 and the source electrode 25, is heated over a temperature, where the ferroelectric layer 22 shows β-phases, and cooled monotonously to the temperature, where the β-phases are shown, or the structure is heated to a temperature, where the ferroelectric layer 22 shows β-phases, and cooled rapidly.

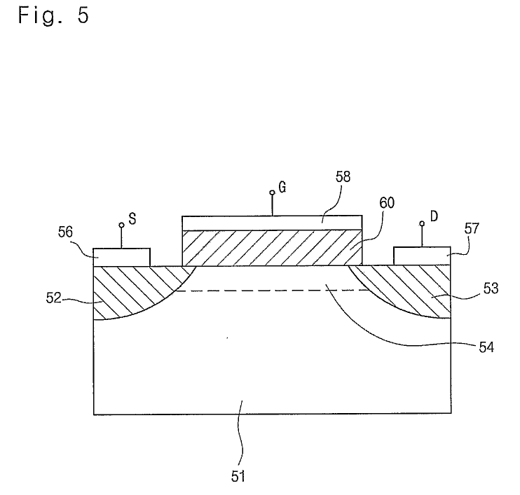

FIG. 5 is a sectional view depicting another structure of a memory device using a ferroelectric organic material in accordance with another embodiment of the present invention.

In the figure, a source region 52 and a drain region 53 are formed in specific regions on a silicon substrate 51, and a ferroelectric thin film or a ferroelectric layer 60 is provided on a channel region 54 between the source and drain regions 52 and 53. Here, the ferroelectric layer 60 is formed with ferroelectric organic materials as described above. The available ferroelectric organic materials may include polyvinylidene fluoride (PVDF), PVDF polymer, PVDF copolymer PVDF terpolymer and, further, odd-numbered nylon, cyano-polymer, their polymer and copolymer. Meanwhile, a source electrode 56, a drain electrode 57 and a gate electrode 58 are arranged on the top of the source region 52, the drain region 53 and the organic ferroelectric layer 60, respectively.

In the structure depicted in FIG. 5, an insulating layer used as a buffer layer is removed, differently from the structure of the general metal-ferroelectric-insulator-semiconductor (MFIS). Accordingly, the structure of the ferroelectric memory device comprising just the ferroelectric layer 60 and the various electrodes 56, 57 and 58 can be simplified like that of the general transistor.

As above, the preferred embodiment of the present invention has been described. However, the above-described embodiment is one of the desirable examples of the present invention and the present invention can be embodied with various modifications within the range, not departing from the spirit and scope of the present invention.

Industrial Applicability

According to the present invention as described above, it is possible to provide an environment-friendly and low cost organic material having excellent ferroelectric characteristics for semiconductor device.

1. In ferroelectric materials used in manufacturing semiconductor devices,
a ferroelectric organic material having a crystal structure of β-phase.

2. The ferroelectric organic material as recited in claim 1,
wherein the ferroelectric organic material is a polyvinylidene fluoride (PVDF).

3. The ferroelectric organic material as recited in claim 1,
wherein the ferroelectric organic material is one selected from the group consisting of PVDF polymer, PVDF copolymer PVDF terpolymer, odd-numbered nylon, cyano-polymer, their polymer and copolymer.
